(19) United States
(12) Patent Application Publication
(10) Pub. No.: US 2004/0057566 A1
(43) Pub. Date: Mar. 25, 2004

(54) Caller ID product and method with the ability to receive and send caller ID information to remote locations

(76) Inventor: Robert Corey Mallory, Richmond, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/252,861

(22) Filed: Sep. 23, 2002

(51) Int. Cl. H04M 1/56; H04M 15/06

(52) U.S. Cl. 379/142.15

(57) ABSTRACT

A caller identification (ID) system includes a first caller ID unit located at a first location. The first caller ID unit is operatively coupled to a telephone network to reveal telephone numbers. A second caller ID unit is coupled to the telephone network and located at a second location, other than the first location. A transmitter is included in the first caller ID unit for transferring caller ID information between the first and second caller ID units over the telephone network such that the caller ID information from the first caller ID unit is conveyed to the second caller ID unit.

### FIELD OF THE INVENTION

The present invention generally relates to network communication services and, more particularly, to a system and method of sending and receiving caller identification information to remote locations over a telephone network.

### BACKGROUND OF THE INVENTION

Caller identification (caller ID or CID) systems currently provide a subscriber with the telephone number of the person or machine calling the subscriber's phone. These systems typically provide a display device, which textually presents the caller information at the subscriber's premises. When a subscriber travels or is otherwise away from the caller ID box, caller ID information is no longer available. Solutions to this problem include a speech synthesis system, which is capable of reading out the caller ID information to a user. The caller id information is spoken back using synthesized speech, but is not stored at the remote location. This requires that the user write down or in some other manner record the information being presented. This is also a slow process the user must wait for the information to be read to them.

Accordingly, a need exists for conveying and storing caller ID information to a remote user in a convenient manner.

### SUMMARY OF THE INVENTION

A caller identification (ID) system in accordance with the present invention includes a first caller ID unit located at a first location. The first caller ID unit is operatively coupled to a telephone network to reveal telephone numbers. A second caller ID unit is coupled to the telephone network and located at a second location, other than the first location. A transmitter is included in the first caller ID unit for transferring caller ID information between the first and second caller ID units over the telephone network such that the caller ID information from the first caller ID unit is conveyed to the second caller ID unit.

A method for transferring caller identification (ID) information in accordance with the present invention includes receiving caller ID information over a telephone network from a telephone company at a first caller ID unit. Responsive to an event, the caller ID information is transmitted to a remote unit over the telephone network. The caller ID information is processed at the remote unit.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a schematic diagram of a caller identification (ID) system having the capability of sending caller identification information remotely in accordance with the present invention;

FIG. 2 is a block/flow diagram showing a method for transferring caller ID information in accordance with one embodiment of the present invention; and

FIG. 3 is a block/flow diagram showing a method for transferring caller ID information in accordance with another embodiment of the present invention.

It should be understood that the drawings are for purposes of illustrating the concepts of the invention and are not necessarily the only possible configuration for illustrating the invention.

### DETAILED DESCRIPTION OF THE INVENTION

The present invention provides a system and method for transporting and storing caller identification information over a telephone network to a remote user location. The caller identification (caller ID or CID) information is received remotely and stored in a textual form for easy retrieval and usage. In one embodiment, the user is able to retrieve stored caller ID information from a pre-designated location, for example, home/office, when they are traveling or otherwise not present at the pre-designated location.

It should be understood that the elements shown in the FIGS. may be implemented in various forms of hardware, software or combinations thereof. Preferably, these elements are implemented in hardware on one or more appropriately programmed general-purpose devices, which may include a processor, memory and input/output interfaces. The elements shown in the FIGS. may also be implemented in software on one or more of the appropriately programmed general-purpose devices.

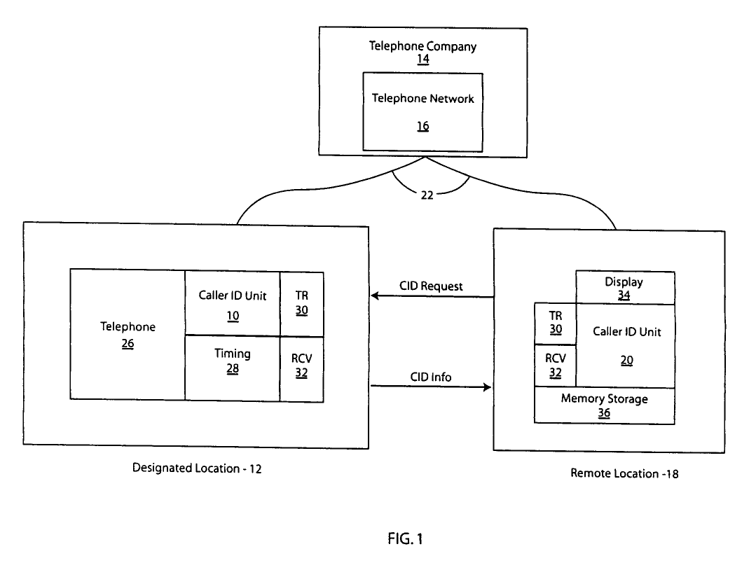

Referring now in specific detail to the drawings in which like reference numerals identify similar or identical elements throughout the several views, and initially to FIG. 1, a schematic diagram shows an illustrative caller ID system in accordance with the present invention. The illustrative embodiment shows a caller ID box 10 at a subscriber's pre-designated location 12 (e.g., home, office or other location e.g., where a phone bill is sent). Box 10 includes the capability of receiving caller ID information from a telephone company 14 over a telephone network 16. Box 10 stores the caller ID information for one or more telephone calls. Box 10 is preferably coupled to a telephone 26 or other communications device, which can receive telephone calls.

Box 10 may be programmed to intermittently send stored telephone numbers to a remote location 18. In other words, box 10 may optionally include a timing device 28 which triggers a transmit mode to send telephone numbers stored therein after a predetermined amount of time has elapsed. The caller ID information may be sent to a programmed destination by employing a telephone number or other destination address (e.g., website, modem address, etc.) stored in its memory.

Alternately, box 10 may be configured to receive a command from remote location 18 by, for example, a subscriber's request made by employing a telephone, personal digital assistant (PDA), a computer or other device. A caller ID box 20 or other unit capable of receiving caller ID information is located at remote site 18 and receives the caller ID information from caller ID box 10. When a call is placed to the telephone, which box 10 is connected to, a code can be entered or other action may be taken to set box 10 into a transmit mode. Box 10 would then transmit the caller ID information to unit 20 from which the command is made. For purposes of this disclosure, remote site 18 includes any communication device other than the predesignated location device. The remote device may be physically located in the same building or even in the same room and the predesignated device. The difference between the remote site and the predesignated site may be, simply, different in telephone numbers.

The caller ID information sent to unit 20 can be immediately displayed or stored for later retrieval. Handshaking and communication between box 10 and unit 20 is preferably performed over a communication network or link 22. The link 22 may include a telephone network, such as a public switched telephone network (PSTN), a cable network, a wireless network, a satellite network, etc. Once stored the textual caller ID information may be portable along with unit 20. Box 10 includes a transmitter 30 and optionally a receiver 32. Transmitter 30 may employ standard modem protocols, or other transmission protocols (e.g., caller ID type 1, type or type 3 protocols or the like) to send caller ID information to unit 20. Receiver 32 is configured to be responsive to commands received from unit 20. Unit 20 preferably includes a transmitter 30 and a receiver 32 for respectively sending a command and receiving caller ID information (by employing the appropriate protocol(s)).

Communication between box 10 and unit 20 may be handled using existing modem or proprietary protocols. Unit 20 preferably operates using existing caller ID protocols to receive information. With the addition of having the ability to resend the stored caller ID information upon the user request, the user could call home from the office and retrieve the caller ID information that is currently stored in his/her caller ID product at home. Both box 10 and unit 20 would be in an off-hook state and only box 10 would have to be capable of sending the caller ID information. Unit 20 preferably includes a display 34 capable of displaying the caller ID information received therein. In preferred embodiments, unit 20 includes memory storage 36 to store received caller ID info therein.

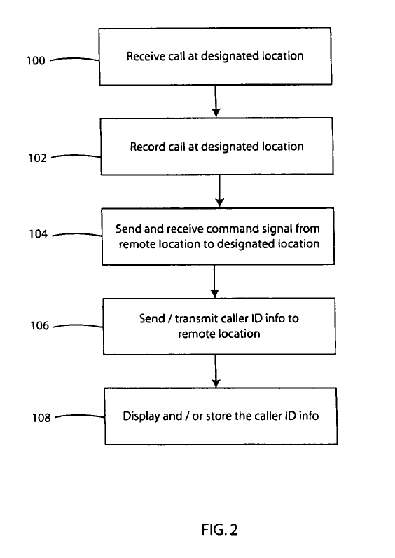

Referring to FIG. 2, a block/flow diagram showing an illustrative method for remotely retrieving caller ID information is shown in accordance with the present invention. In block 100, a call is received by a telephone system at a predesignated location, e.g., a subscriber's home telephone. The subscriber's home telephone includes caller ID service. The caller ID service records the telephone number of the caller in block 102. The caller ID box at the predesignated location includes a transmitter/receiver capable of sending caller ID information through a telephone network when prompted to do so by receiving a command through the telephone network. In block 104, a command signal is sent from a remote location to the caller ID box. The command signal may be generated by, for example, a personal digital assistant, a caller ID box, a telephone having a display, a computer or any other telecommunications device having a display or speaker (which can audibly render the information). In block 106, upon receiving the command, caller ID information is sent from the predesignated location's caller ID box to the remote device. The remote device is preferably able to display and store the information therein, in block 108. The caller ID information from the predesignated location is now made available at the remote location, and may be stored for future reference.

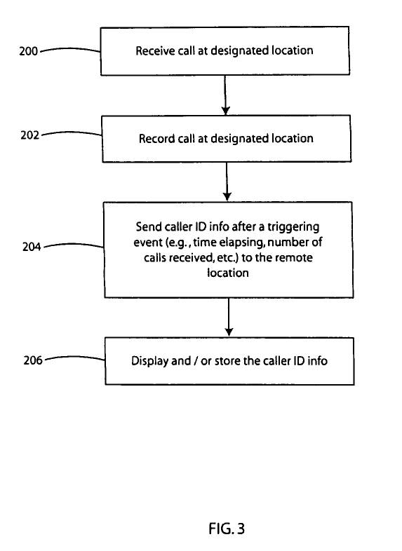

Referring to FIG. 3, a block/flow diagram showing another illustrative method for remotely retrieving caller ID information is shown in accordance with the present invention. In block 200, a call is received by a telephone system at a pre-designated location, e.g., a subscriber's home telephone. The subscriber's home telephone includes caller ID service. The caller ID service records the telephone number of the caller in block 202. The caller ID box at the predesignated location includes a transmitter capable of transmitting the caller ID information over a telephone network after a time interval or other event. Other events may include transmissions of caller ID information after each telephone call is received or after a predetermined number of phone calls have been received.

In block 204, after the triggering event occurs, the caller ID box at the predesignated location sends the caller ID information stored thereon to a remote location. An address or telephone number may be pre-recorded in the caller ID box to identify the destination where the caller ID information will be sent. A device at the remote destination may include, for example, a personal digital assistant, a caller ID box, a telephone having a display, a computer or any other telecommunications device having a display. Caller ID information is sent from the predesignated location's caller ID box to the remote device. The remote device is preferably able to display and store the information therein, in block 206.

Although the embodiment which incorporates the teachings of the present invention has been shown and described in detail herein, those skilled in the art can readily devise many other varied embodiments that still incorporate these teachings. Having described preferred embodiments for caller ID product and method with the ability to receive and send caller ID information to remote locations (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A caller identification (ID) system, comprising:
a first caller ID unit located at a first location and operatively coupled to a communications network to reveal telephone numbers of incoming calls;
a second caller ID unit coupled to the communications network and located at a second location, other than the first location; and
a transmitter included in the first caller ID unit for transferring caller ID information between the first and second caller ID units over the telephone network such that the caller ID information from the first caller ID unit is conveyed to the second caller ID unit.

2. The caller ID system as recited in claim 1, wherein the first caller ID unit includes a timing device to measure intervals of time such that after an interval has elapsed the transmitter transmits the caller ID information to the second caller ID unit.

3. The caller ID system as recited in claim 1, wherein the second caller ID unit includes means for sending a command to the first caller ID unit to enable the transmitter to send the caller ID information to the second caller ID unit.

4. The caller ID system as recited in claim 1, wherein the first caller ID unit includes a caller ID box.

5. The caller ID system as recited in claim 1, wherein the second caller ID unit includes one of a personal digital assistant, a telephone, a caller ID box and a computer.

6. The caller ID system as recited in claim 1, wherein the first caller ID unit and the second caller ID unit communicate using a modem protocol.

7. The caller ID system as recited in claim 1, wherein the second caller ID unit includes a display for textually displaying received caller ID information.

8. The caller ID system as recited in claim 1, wherein the second caller ID unit includes a memory to store the caller ID information.

9. A method for transferring caller identification (ID) information, comprising the steps of:
receiving caller ID information over a communications at a first caller ID unit;
responsive to an event, transmitting the caller ID information to a remote unit over the telephone network; and
processing the caller ID information at the remote unit.

10. The method as recited in claim 9, wherein the event includes a time interval elapsing.

11. The method as recited in claim 9, wherein the event includes receiving a predetermined number of telephone calls by the first caller ID unit.

12. The method as recited in claim 9, wherein the step of processing the caller ID information at the remote unit includes the step of storing the caller ID information at the remote unit.

13. The method as recited in claim 9, wherein the step of processing the caller ID information at the remote unit includes the step of textually displaying the caller ID information on the remote unit.

14. The method as recited in claim 9, further comprising the step of sending a command to the first caller ID unit as the event.

15. The method as recited in claim 9, wherein the remote unit includes one of a personal digital assistant, a telephone, a caller ID box and a computer.

16. The method as recited in claim 9, further comprising the steps of prerecording a destination of the remote unit in the first caller ID unit wherein the step of transmitting sends the caller ID information to the prerecorded destination.
